(19) United States
(12) Patent Application Publication
(10) Pub. No.: US 2023/0150858 A1
(43) Pub. Date: May 18, 2023

(54) CERAMIC ARTICLE WITH ENHANCED STRUCTURAL AND THERMAL STABILITY AND METHOD OF MAKING SAME

(71) Applicant: Blasch Precision Ceramics, Inc., Menands, NY (US)

(72) Inventors: William Patrick Russell, East Greenbush, NY (US); Scott David Sheppard, Cincinnati, OH (US); Alexandra Danielle Markle, Latham, NY (US)

(21) Appl. No.: 18/055,445

(22) Filed: Nov. 15, 2022

Related U.S. Application Data
(60) Provisional application No. 63/279,278, filed on Nov. 15, 2021.

(51) Int. Cl. C03B 37/04; C04B 35/82; C04B 35/64; C04B 41/53; C04B 41/00; B23K 26/402; B23K 26/382

(52) U.S. Cl. CPC C03B 37/045; C03B 37/047; C04B 35/82; C04B 35/64; C04B 41/5346; C04B 41/0036; B23K 26/402; B23K 26/382; C04B 2235/3826; C04B 2235/3852; C04B 2235/5208; C04B 41/91

(57) ABSTRACT

A ceramic spinner and a method of making the same is provided. The ceramic spinner includes: a top portion with a first opening, the first opening having a first diameter; a base portion with a second opening, the second opening having a second diameter smaller than the first diameter; a cylindrical portion extending between the top portion and the base portion, the cylindrical portion including a peripheral outer wall, a peripheral inner wall, and a plurality of through holes extending between the peripheral outer wall and the peripheral inner wall. The cylindrical portion may include a material having a module of rupture (MOR) exceeding 100 MPa, a Mohs hardness exceeding 8, or a Young's Modulus exceeding 250 GPa, or any combinations thereof.

### CROSS REFERENCE TO RELATED APPLICATIONS

This application claims the benefit of the filing date of U.S. provisional application No. 63/279,278 filed on Nov. 15, 2021, which is incorporated by reference in its entirely herein.

### FIELD

The disclosure relates generally to a ceramic article and a method of making the same, and more particularly, embodiments of the disclosure relate to a ceramic article with enhanced structural and thermal stability for glass wool production and a method of making the same.

### BACKGROUND

Glass wool is typically produced from a sand, limestone, soda ash, and recycled glass. In a typical process, these constituents are crushed and mixed, before being melted and refined together at high temperatures, for example, temperatures in excess of 2650° F. The resulting molten material (or “molten glass”) is then gravity fed into a rotary cylinder or a spinning bowl, known as a “spinner” or “fiberizer.” The spinner typically has a large array of small through holes. As the spinner is rapidly rotated, the centrifugal forces pulls the molten material toward the outer wall of the spinner and through the array of the small through holes of the spinner to continuously cast thin strands. For use as fiber glass wool, an ultralight insulative material used for applications such as housing and aerospace, the strands are mixed with resins and cured into the final product.

### BRIEF DESCRIPTION

All aspects, examples and features mentioned below can be combined in any technically possible way.

An aspect of the disclosure provides a ceramic article comprising: a top portion with a first opening, the first opening having a first diameter; a base portion with a second opening, the second opening having a second diameter smaller than the first diameter; a cylindrical portion extending between the top portion and the base portion, the cylindrical portion including a peripheral outer wall, a peripheral inner wall, and a plurality of through holes extending between the peripheral outer wall and the peripheral inner wall, wherein the cylindrical portion comprises a material having a module of rupture (MOR) exceeding 100 Megapascals (MPa), a Mohs hardness exceeding 8, or a Young's Modulus exceeding 250 Gigapascals (GPa), or any combinations thereof.

Another aspect of the disclosure includes the preceding aspect, and wherein the cylindrical portion includes a first region adjacent and surrounding each of the plurality of through holes and a second region adjacent the first region, wherein the material in the first region has a first characteristics, and the material in the second region includes a second characteristics that is different than the first characteristics.

Another aspect of the disclosure includes any of the preceding aspects, and the material in the first region has a higher density than that of the material in the second region, thereby providing a higher-density inner surface surrounding each of the plurality of through holes.

Another aspect of the disclosure includes any of the preceding aspects, and wherein the higher-density inner surface has an average width of about 50 micrometers (μm).

Another aspect of the disclosure includes any of the preceding aspects, and wherein the material has a thermal conductivity in a range of 15-75 Watts per meter per degree Celsius, or a thermal expansion in a range of 3-6 micrometer per meter per degree Celsius, or both.

Another aspect of the disclosure includes any of the preceding aspects, and wherein the cylindrical portion extends radially between the top portion and the base portion, and the base portion includes a laterally extending base portion and a sloped base portion coupling the laterally extending base portion to the radially extending cylindrical portion.

Another aspect of the disclosure includes any of the preceding aspects, and wherein the plurality of through holes has an average inner diameter range from about 250 μm to about 2.5 millimeter (mm).

Another aspect of the disclosure includes any of the preceding aspects, and wherein the material comprises a nitride bonded silicon carbide material.

Another aspect of the disclosure includes any of the preceding aspects, and wherein the ceramic article is a glass wool spinner.

An aspect of the disclosure provides a method for preparing an article from a cast ceramic workpiece, the method comprising: sintering the cast ceramic workpiece to form a sintered ceramic body, the sintered ceramic body including: a top portion with a first opening, the first opening having a first diameter; a base portion with a second opening, the second opening having a second diameter smaller than the first diameter; and a cylindrical portion extending between the top portion and the base portion, the cylindrical portion including a peripheral outer wall and a peripheral inner wall, and forming a plurality of through holes extending between the peripheral outer wall and the peripheral inner wall of the cylindrical portion, wherein the cylindrical portion comprises a material having a module of rupture (MOR) exceeding 100 Megapascals (MPa), a Mohs hardness exceeding 8, or a Young's Modulus exceeding 250 Gigapascals (GPa), or any combinations thereof.

Another aspect of the disclosure includes the preceding method, and the forming further comprises: determining a region of interests (ROI) in the sintered ceramic body for forming the plurality of through holes; directing an energy source to the ROI; and forming the plurality of through holes within the ROI, each of the plurality of through holes extending between the peripheral outer wall and the peripheral inner wall of the cylindrical portion of the sintered ceramic body.

Another aspect of the disclosure includes any of the preceding methods, and wherein the energy source is an ultrasound energy.

Another aspect of the disclosure includes any of the preceding methods, and wherein the energy source is a laser.

Another aspect of the disclosure includes any of the preceding methods, further comprising: liquifying and vaporizing the material within the ROI in forming the plurality of through holes within the ROI; liquifying, without vaporizing, the material surrounding each of the plurality of through holes and forming a first region adjacent and surrounding each of the plurality of through holes; and allowing the material in the first region to resolidify, wherein the material in the first region has a first characteristics, and the material in a second region adjacent the first region has a second characteristics that is different than the first characteristics.

Another aspect of the disclosure includes any of the preceding methods, and further comprising: forming a higher-density inner surface of the first region, wherein the higher-density inner surface extends laterally through both the peripheral outer wall and the peripheral inner wall.

Another aspect of the disclosure includes any of the preceding methods, and wherein the material in the first region has a higher material density than that of the second region of the cylindrical portion.

Another aspect of the disclosure includes any of the preceding methods, and wherein the higher-density inner surface has an average width of about 50 μm.

Another aspect of the disclosure includes any of the preceding methods, and wherein the material has a thermal conductivity in a range of 15-75 Watts per meter per degree Celsius.

Another aspect of the disclosure includes any of the preceding methods, and wherein the material has a thermal expansion in a range of 3-6 micrometer per meter per degree Celsius.

Another aspect of the disclosure includes any of the preceding methods, and wherein the plurality of through holes has an average inner diameter in a range of about 250 μm to about 2.5 mm.

Another aspect of the disclosure includes any of the preceding methods, and wherein the material comprises a nitride bonded silicon carbide material.

Another aspect of the disclosure includes any of the preceding methods, and wherein the article is a glass wool spinner.

Another aspect of the disclosure includes any of the preceding methods, and wherein the cast ceramic workpiece is a singular cast ceramic workpiece.

An aspect of the disclosure provides a ceramic spinner comprising: a top portion with a first opening, the first opening having a first diameter; a base portion with a second opening, the second opening having a second diameter smaller than the first diameter; a cylindrical portion extending between the top portion and the base portion, the cylindrical portion including a peripheral outer wall, a peripheral inner wall, and a plurality of through holes extending between the peripheral outer wall and the peripheral inner wall, wherein the cylindrical portion further includes a first region surrounding each of the plurality of holes and a second region adjacent the first region, and wherein a material in the first region has a first characteristics, and a material in the second region has a second characteristics that is different than the first characteristics.

Another aspect of the disclosure includes any of the preceding aspects, and wherein the cylindrical portion includes a material having a module of rupture (MOR) exceeding 100 MPa, a Mohs hardness exceeding 8, or a Young's Modulus exceeding 250 GPa, or any combinations thereof.

Another aspect of the disclosure includes any of the preceding aspects, and wherein the material having the first characteristics has a higher density than that of the material having the second characteristics, thereby providing a higher-density inner surface surrounding each of the plurality of holes.

Another aspect of the disclosure includes any of the preceding aspects, wherein the higher-density inner surface has an average width of about 50 μm.

Another aspect of the disclosure includes any of the preceding aspects, and wherein the material has a thermal conductivity in a range of 15-75 Watts per meter per degree Celsius.

Another aspect of the disclosure includes any of the preceding aspects, and wherein the material has a thermal expansion in a range of 3-6 micrometer per meter per degree Celsius.

Another aspect of the disclosure includes any of the preceding aspects, and wherein each of the plurality of holes has an average inner diameter in a range of about 250 μm to about 2.5 mm.

Another aspect of the disclosure includes any of the preceding aspects, and wherein the material comprises a nitride bonded silicon carbide.

Another aspect of the disclosure includes any of the preceding aspects, and where the ceramic spinner is a glass wool spinner.

Another aspect of the disclosure includes any of the preceding aspects, and wherein the cast ceramic workpiece is a singular cast ceramic workpiece.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a flow diagram of a rotary spin process using a ceramic spinner, according to embodiments of the current disclosure.

FIG. 2A is a perspective view of a ceramic spinner, according to embodiments of the current disclosure; FIG. 2B is a top view of the ceramic spinner of FIG. 2A, according to embodiments of the disclosure; FIG. 2C is a cross sectional view of the ceramic spinner along the line K-K of FIG. 2B, according to embodiments of the disclosure.

FIG. 3 is a flow chart of a method of preparing an article from a cast ceramic workpiece, according to embodiments of the current disclosure.

FIG. 4 is a flow chart illustrating additional method steps in preparing an article from a cast ceramic workpiece, according to embodiments of the current disclosure.

FIG. 5 illustrates a rotary ultrasonic drilling process for drilling holes in a ceramic workpiece, according to embodiments of the current disclosure.

FIG. 6 is a cross-sectional view of a portion of a ceramic article where a plurality of through holes are made via a laser drilling, according to embodiments of the current disclosure.

FIG. 7 is a magnified cross-sectional view of a portion of the ceramic article of FIG. 6, showing a through hole and surrounding structural details.

FIG. 8A shows a perspective view of another embodiment of ceramic spinner, according to embodiments of the current disclosure; FIG. 8B is a top view of the ceramic spinner of FIG. 8A, according to embodiments of the disclosure; FIG. 8C is a cross sectional view of the ceramic spinner along the line A-A of FIG. 8B, according to embodiments of the disclosure.

FIG. 9 illustrates a result of a finite element analysis (FEA) that determines the stresses imparted on the ceramic article of FIG. 8A by the rotational forces, according to embodiments of the current disclosure.

FIG. 10 shows more details of the finite element analysis (FEA) results of a cross sectional view of a portion of the ceramic article taken along the line S-S of FIG. 9, according to embodiments of the current disclosure.

FIGS. 11A and 11B compare measurements of stress (σ) vs strain (ε) curves of a reference titanium alloy metal material (FIG. 11A) and a silicon carbide material (FIG. 11B) of the instant disclosure, according to embodiments of the current disclosure.

FIG. 12 compares parameters for rigidity (Youngs Modulus, GPa) and hardness (MOH) of various materials for a spinner, according to embodiments of the current disclosure.

FIG. 13 shows a temperature load over time profile of a thermal shock test, according to embodiments of the current disclosure.

FIG. 14 shows comparison of mechanical strength (MPa) and density (lb/in³) profile of various materials for a spinner, according to embodiments of the current disclosure.

FIG. 15 provides a comparison of thermal expansion and thermal conductivity of various materials for a spinner, according to embodiments of the current disclosure.

FIG. 16 summarizes a comparison of the material specifications matrix between the materials of the current disclosure and certain reference metals, according to embodiments of the current disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

### DETAILED DESCRIPTION

Certain embodiments will now be described to provide an overall understanding of the principles of the structure, function, manufacture, and use of the methods, systems, and devices disclosed herein. One or more examples of these embodiments are illustrated in accompanying drawings. Those skilled in the art will understand that methods, systems, and devices specifically described herein and illustrated in the accompanying drawings are non-limiting embodiments. Features illustrated or described in connection with one embodiment may be combined with features of other embodiments. Such modifications and variations are intended to be included within the scope of the present disclosure.

As an initial matter, in order to clearly describe the subject matter of the current disclosure, it will become necessary to select certain terminology when referring to and describing relevant machine components. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

It is often required to describe parts that are disposed at differing radial positions with regard to a center axis. The term “radial” refers to movement or position perpendicular to an axis. For example, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. Finally, the term “circumferential” refers to movement or position around an axis. It will be appreciated that such terms may be applied in relation to the center axis of the turbine.

In addition, several descriptive terms may be used regularly herein, as described below. The terms “first”, “second”, and “third” may be used interchangeably to distinguish one component from another and are not intended to signify location or importance of the individual components.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur or that the subsequently describe component or element may or may not be present, and that the description includes instances where the event occurs or the component is present and instances where it does not or is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The current disclosure provides a ceramic article and method of making the same. In particular, embodiments of the disclosure relate to a ceramic article with enhanced structural and thermal stability for fiber glass wool production and method of making the same.

Traditionally, metallic spinners have been used in producing glass wool, with a range of alloys used over the years, for example, structurally hard alloys with high operating temperatures. The spinners typically have a very large number of miniscule holes (e.g., 40,000+ holes at about 0.016″, i.e., about 400 micrometers (μm) in diameter for each hole). At the startup of production, each hole is its smallest and best sized to produce the highest quality glass wool. As the hot and viscous molten glass passes through the holes it mechanically erodes them through friction and fatigue, increasing the inner dimension of the holes, and by relation, the outer dimension of the produced glass wool. This decreases the quality of the glass wool, and typically within only 120 hours of service the otherwise functional metal spinner is no longer able to produce quality fiber glass wool, and then the entire process must be shut down for the metallic spinner to be replaced and preheated for startup.

Therefore, the market is still in need for a spinner with high structural and thermal stability at high temperatures, suitable for use in a rotary spin process in producing high quality glass wool product.

The current disclosure solves the issues faced by the conventional metal spinners by providing a ceramic spinner or article including a plurality of through holes and method of making the same, where the ceramic spinner has high mechanical stability at high temperatures and enhanced erosion resistance. More specifically, the solution developed in the current disclosure utilizes a combination of ceramics materials with specific parameters and unique machining methods to generate a ceramic article suitable for use in applications including, but not limited to, a rotary spin process in producing high quality glass wool products.

As will be discussed later, various factors need to be considered in designing a non-metal spinner. Furthermore, complex interplay between design parameters/factors adds to the challenges in material selection. The field has consistently overlooked and/or dismissed the possibility of using a refractory ceramic to replace the metal. Likely the yield strength and brittleness of refractory ceramic such as fused silica or alumina often disqualify these materials. Furthermore, the manufacturing limitations of ceramic materials, especially the hardest ones, traditionally led the industry away from the ceramic materials and toward favoring softer, and more machinable metals.

Method of manufacturing ceramic spinners posts additional challenges. For example, no commercial method exists to date to form a functional spinner from a singular cast ceramic workpiece including silicon carbide material. One of the manufacturing challenges is to produce an array of tiny through holes throughout a thin-walled body of the ceramic workpiece. The current disclosure combines the benefits of data-guided design of mechanical properties of a ceramic workpiece with the precision of specialized processing, such as a precision laser drilling, to manufacture each individual through hole in its exact location along the ceramic workpiece, and provides a spinner that meets the design specification suitable for producing high quality glass wool products.

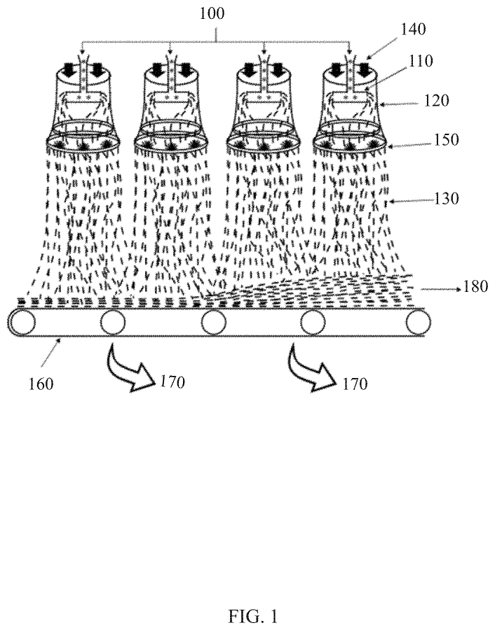

FIG. 1 illustrates a rotary spin process in processing a molten glass, using a ceramic spinner of the instant disclosure. In the process, a molten glass 100, once formed, is gravity fed into a ceramic spinner 110. The centrifugal forces produced by the rapidly spinning spinner 110 pulls the molten material 100 toward the outer wall of the spinner 110 and through an array of tiny, precisely manufactured through holes 120 to continuously cast thin strands of fiber glass 130, typically ranging from 3 to 25 μm in diameter. An outside stream of high velocity, hot air then stretches the strands 130, and a separate stream of highly turbulent cold air 140 hardens them to the point of breakage (attenuation). At the same time, a binder spray 150 is applied to bond the fibers 130 together, with a typical binder solution including phenol-formaldehyde resin, water, urea, lignin, silane, and ammonia, as well as coloring agents. The formed glass fibers 130 are then transported by a conveyor 160 to a curing oven 180 for further treatment while forming exhaust 170 is pulled through conveyor 160.

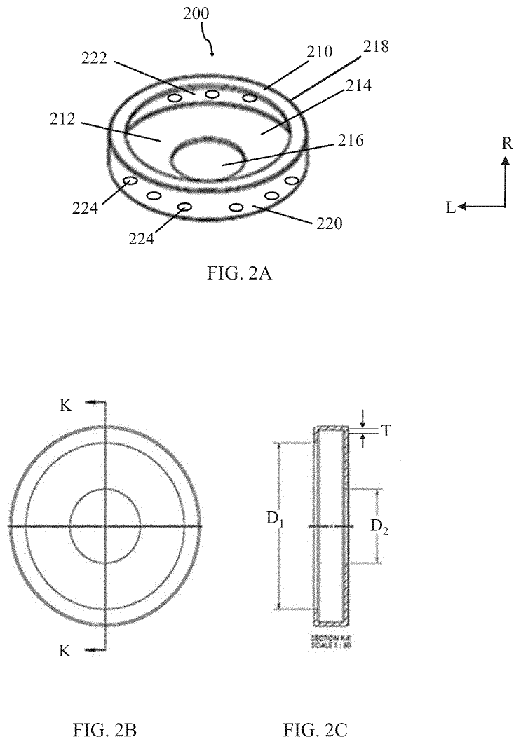

FIG. 2A shows a perspective view of a ceramic article 200, for example, a ceramic spinner, according to embodiments of the current disclosure; FIG. 2B is a top view of the ceramic article of FIG. 2A; and FIG. 2C is a cross sectional view of the ceramic article along the line K-K of FIG. 2B, according to embodiments of the disclosure. As illustrated in FIG. 2A, the ceramic article 200 may include: a top portion 210 with a first opening 212, the first opening 212 having a first diameter D₁ (FIG. 2C); a base portion 214 with a second opening 216 having a second diameter D₂ smaller than the first diameter D₁ (FIG. 2C); and a cylindrical portion 218 extending between the top portion 210 and the base portion 214, the cylindrical portion 218 having a peripheral outer wall 220, a peripheral inner wall 222, and a plurality of through holes 224 extending between the peripheral outer wall 220 and the peripheral inner wall 222. In embodiments, top portion 210 extends laterally (e.g., direction “L” in FIG. 2A). In embodiments, cylindrical portion 218 extends radially between top portion 210 and base portion 214 (e.g., direction “R” in FIG. 2A). In embodiments, cylindrical portion 218 has a thin wall thickness T defined by the peripheral outer wall 220 and the peripheral inner wall 222. In embodiments, D₁ may be in a range of about 200-400 mm, or about 300-350 mm, or about 300-320 mm. D₂ may be in a range of about 50-300 mm, or in a range of about 100-250 mm, or in a range of about 130-210 mm. T may be in a range of 1-20 mm, or in a range of 5-15 mm, or about 7-11 mm. It is to be understood that dimensions of D₁, D₂ and T are provided as non-limiting examples, and that the embodiments of the current disclosure are not limited to the disclosed dimensions. Various dimensions of the ceramic article are intended to be included within the scope of the present disclosure. Furthermore, the ceramic article may be developed or used for different applications, including, but not limited to, a ceramic spinner for glass wool production.

In certain embodiments, the cylindrical portion 218, including the peripheral outer wall 220 and the peripheral inner wall 222, includes a material having a module of rupture (MOR) exceeding 100 Megapascals (MPa), a Mohs hardness exceeding 8, or a Young's Modulus exceeding 250 Gigapascals (GPa), or any combinations thereof. In some embodiments, the material includes a nitride bonded silicon carbide material. In embodiments, the material has a thermal conductivity in a range of 15-75 Watts per meter per degree Celsius. In some embodiments, the material has a thermal expansion in a range of 3-6 micro-meter per meter per degree Celsius.

In embodiments, the plurality of through holes has an average inner diameter range from about 250 micrometers (μm) to about 2.5 millimeters (mm).

In some embodiments, the ceramic spinner of FIGS. 2A-2C includes a singular cast ceramic body.

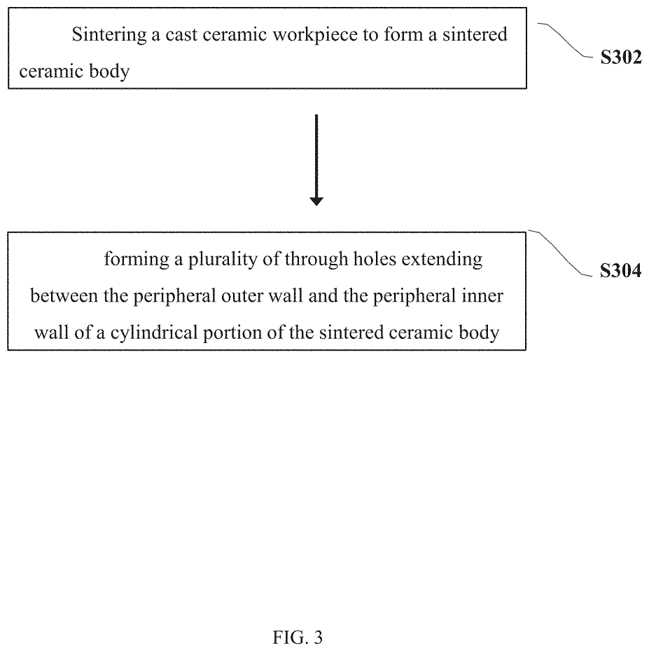

FIG. 3 is a flow chart of a method for preparing a ceramic article, according to embodiments of the disclosure. The method may include: sintering a cast ceramic workpiece to form a sintered ceramic body (S302), and forming a plurality of through holes extending between the peripheral outer wall and the peripheral inner wall of a cylindrical portion of the sintered ceramic body (S304). In embodiments, the sintered ceramic body may include: a top portion with a first opening, the first opening having a first diameter; a base portion with a second opening, the second opening having a second diameter smaller than the first diameter; and a cylindrical portion extending between the top portion and the base portion, the cylindrical portion including a peripheral outer wall and a peripheral inner wall, and forming a plurality of through holes extending between the peripheral outer wall and the peripheral inner wall of the cylindrical portion, where the peripheral outer wall and the peripheral inner wall include a material having a module of rupture (MOR) exceeding 100 Megapascals (MPa), a Mohs hardness exceeding 8, or a Young's Modulus exceeding 250 Gigapascals (GPa), or any combinations thereof.

In some embodiments, the ceramic article is prepared from a singular cast ceramic workpiece and the sintering step includes sintering a singular cast ceramic workpiece. In embodiments, the ceramic article is prepared from a singular cast ceramic workpiece including a silicon carbide material. In embodiments, the ceramic article is prepared from a singular cast ceramic workpiece including a nitride bonded silicon carbide material.

In embodiments, the ceramic article is a glass wool spinner.

In some embodiments, the material has a thermal conductivity in a range of 15-75 Watts per meter per degree Celsius. In some embodiments, the material has a thermal expansion in a range of 3-6 micro-meter per meter per degree Celsius.

In embodiments, the plurality of through holes has an average inner diameter range from about 250 micrometers (μm) to about 2.5 millimeters (mm).

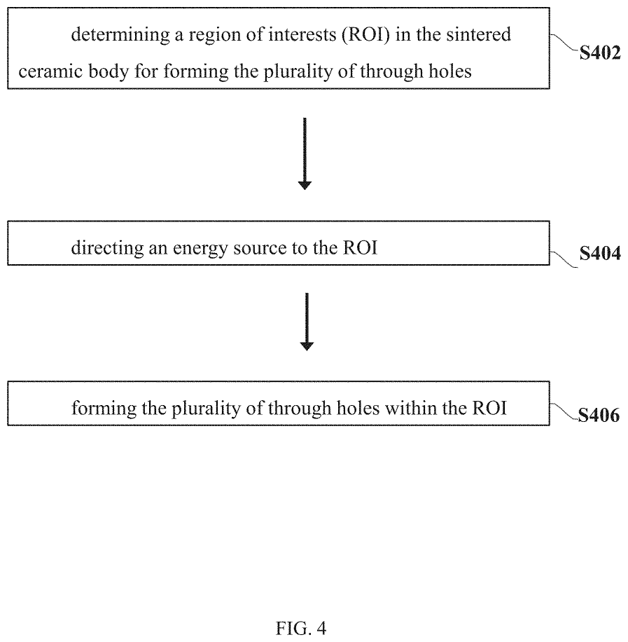

FIG. 4 is a flow chart illustrating additional method steps for preparing a ceramic article. The method may further include: determining a region of interests (ROI) in the sintered ceramic body for forming the plurality of through holes (S402); directing an energy source to the ROI in the sintered ceramic body (S404); and forming the plurality of through holes within the ROI (S406). In embodiments, each of the plurality of through holes extends between the peripheral outer wall and the peripheral inner wall of the cylindrical portion.

In embodiments, the energy source is an ultrasound energy. In embodiments, the energy source is a laser.

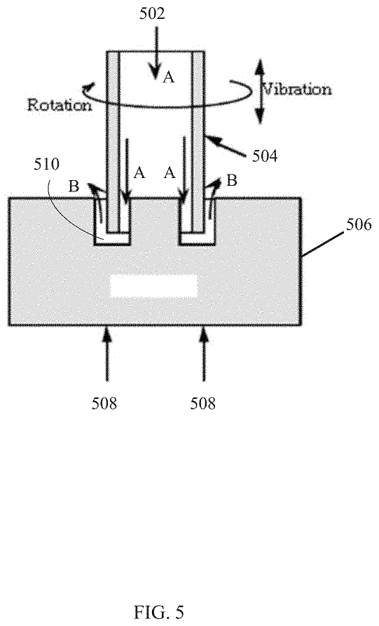

FIG. 5 illustrates a rotary ultrasonic drilling process for drilling holes in a ceramic workpiece. In embodiments, forming the plurality of holes could be achieved by a rotary ultrasonic drilling process. Conventional methods of machining a ceramics workpiece uses a rotary drill bit which grinds material away in order to drill holes on the ceramic workpiece, which causes sufficient wear and difficulty. In contrast, in certain embodiments of the current disclosure, a rotary ultrasonic drilling utilizing an abrasive coolant 502 is used. The abrasive coolant 502 is sprayed through a core drill 504 in a direction A onto a ceramic workpiece 506, and flows out of core drill 504 in a direction B. Applying vibration and rotation of core drill 504 and constant force 508 facilitates the drilling to produce a plurality of holes 510. Compared to the conventional drilling method, the rotary ultrasonic drilling process of the instant disclosure improves brittle fracture mechanism and provides much higher machining rate (6-10 times higher than conventional drilling) and more cost-effective results.

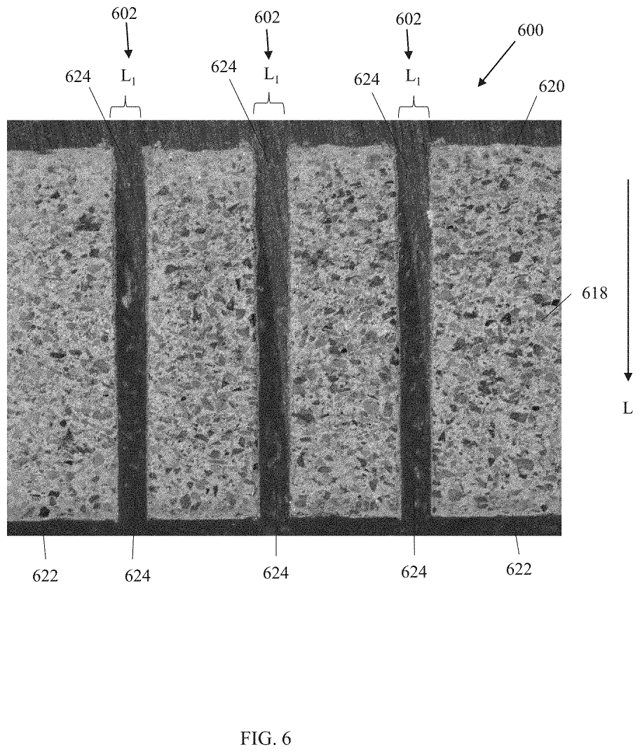

FIG. 6 is a cross-sectional view of a portion of a ceramic article where a plurality of through holes 624 are made via a laser drilling. The laser drilling provides another unique method for producing embodiments of the instant disclosure. Rather than relying on a conventional method of mechanically abrading and grinding ceramic material away, the laser drilling utilizes optical amplification to rapidly heat and vaporize the ceramic material and to generate a plurality of through holes in the ceramic article. This process has shown favorable results, achieving a plurality of straight bores in the ceramic workpiece. As illustrated in FIG. 6, a region of interests (ROI) 602 is determined in a sintered ceramic body 600 for forming the plurality of through holes. A laser energy source is then directed to the ROI 602. As the laser energy source is applied to ROI 602, the portion of the ceramic material inside the ROI 602 along the path of the laser is liquified and vaporized, forming each of the plurality of through holes 624 within a respective ROI 602, each of the plurality of through holes extending between a peripheral outer wall and the peripheral inner wall. Each hole extends between a portion of a peripheral outer wall 620 and a portion of a peripheral inner wall 622. Each through hole 624 has a diameter L₁ between about 250 micrometer (μm) and 2500 or between about 250 μm and 2000 um, between about 300 μm and 1000 um, between about 350 and 500 um, or between about 400 μm and 450 um. No cracking was observed in the laser drilling of the through holes.

In embodiments, the ceramic workpiece of FIG. 6 may include a nitride bonded silicon carbide material. It is to be understood that the embodiment illustrated in FIG. 6 is only a non-limiting embodiment of the current disclosure, and that other ceramic materials may also be used in the ceramic workpiece. Furthermore, other dimension ranges and various patterns and complex array of the through holes can also be achieved with the methods of the current disclosure and are within the scope of the current disclosure.

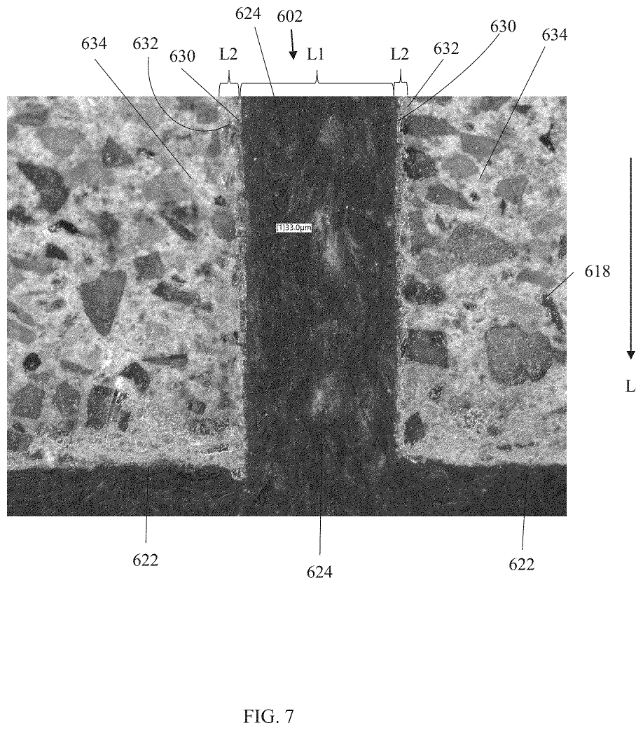

FIG. 7 is a magnified cross-sectional view of a portion of the ceramic article of FIG. 6, showing a through hole 624 and its surrounding structural details made via the laser drilling as described in FIG. 6. Each through hole 624 extends between a portion of a peripheral outer wall 620 and a portion of a peripheral inner wall 622 in a direction “L” (similar to the direction “L” of FIGS. 2A, 6 and 8A). Each hole 624 has a diameter L₁ with a dimension as similarly described in FIG. 6. In embodiments as illustrated in FIG. 7, as the laser energy source is applied to ROI 602, the portion of the ceramic material within the ROI 602 along the path of the laser (direction “L”) is liquified and vaporized, forming through hole 624 within ROI 602, the through hole 624 extending laterally (e.g., in direction “L” shown in FIG. 2A) between the peripheral outer wall 620 and the peripheral inner wall 622 (FIG. 6).

During laser drilling, a portion of the ceramic material along a peripheral inner surface 630 of the through hole 624 is heated to liquification, but not vaporized. This material then re-solidifies along the course of the through hole 624 (i.e., direction “L”), forming a first region 632 adjacent and surrounding the through hole 624 that has a characteristics that is different than a characteristics of the existing (i.e., second region 634) of the cylindrical portion 618 adjacent the first region 632. The characteristics used herein and throughout the disclosure may include, but not limited to, a density of the material, surface roughness, etc. in each respective region. For example, in embodiments, a portion of the ceramic material along a peripheral inner surface 630 of the through hole 624 is heated to liquification, but not vaporized, then re-solidifies along the course of the through hole 624 (i.e., direction “L”), forming a first region 632 adjacent and surrounding the through hole 624 that has a higher material density than that of the existing (i.e., second region 634) of the cylindrical portion 618 adjacent the first region 632. In certain embodiments, the first region 632, which includes the continuous peripheral inner surface 630, has an average width L₂ in a range of between about 30 μm and about 51 μm Differential density between the first region 632 and the second region 634 of the cylindrical portion is beneficial because it increases hardness and produces milder flow characteristics as the hot molten glass or hot gas flows through the plurality of through holes 624, as opposed to contact with a jagged surface. It is to be understood that the dimension of L₁ and L₂ are provided only as non-limiting examples. Other ranges of diameters and various patterns and complex array of the holes can also be achieved and are within the scope of the current disclosure.

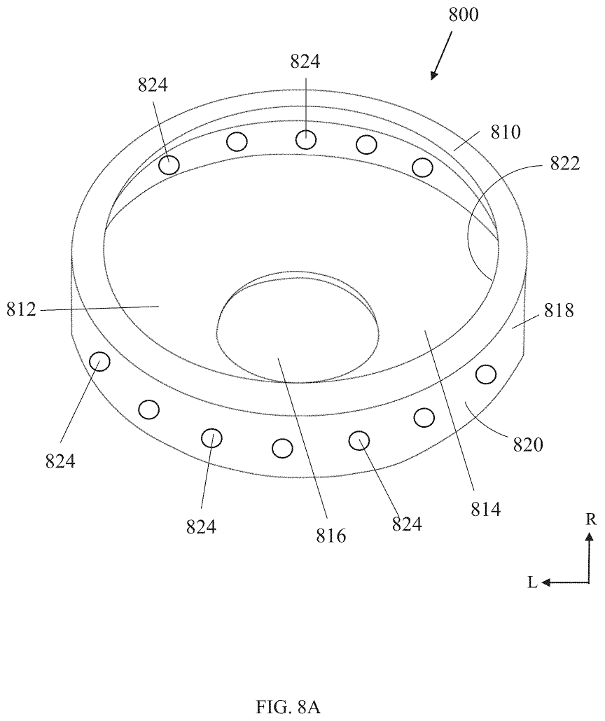

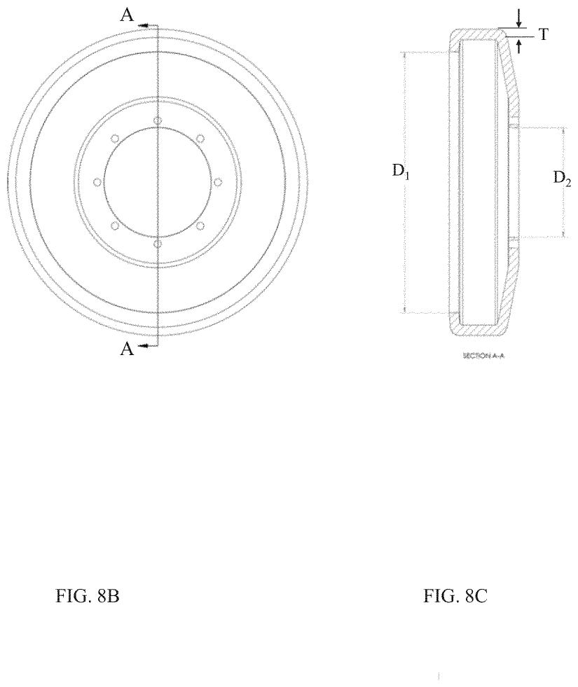

FIG. 8A shows a perspective view of another embodiment of a ceramic article, for example, a ceramic spinner; FIG. 8B is a top view of the ceramic article of FIG. 8A; FIG. 8C is a cross sectional view of the ceramic article along the line A-A of FIG. 8B, according to embodiments of the disclosure. As illustrated in FIG. 8A, a ceramic article 800 includes: a top portion 810 with a first opening 812, the first opening 812 having a first diameter D₁ (FIG. 8C); a base portion 814 with a second opening 816 having a second diameter D₂ smaller than the first diameter D₁ (FIG. 8C); and a cylindrical portion 818 extending between top portion 810 and base portion 814, the cylindrical portion 818 having a peripheral outer wall 820, a peripheral inner wall 822, and a plurality of through holes 824 extending between peripheral outer wall 820 and peripheral inner wall 822 of cylindrical portion 818. In embodiments, the top portion 810 extends laterally (e.g., direction “L”). In embodiments, cylindrical portion 818 extends radially between top portion 810 and base portion 814 (e.g., direction “R”). In embodiments, cylindrical portion 818 has a wall thickness T defined by peripheral outer wall 820 and peripheral inner wall 822 (FIG. 8C). In embodiments, D₁ may be in a range of about 200-400 mm, or about 300-350 mm, or about 300-320 mm. D₂ may be in a range of about 50-300 mm, or in a range of about 100-250 mm, or in a range of about 130-210 mm. T may be in a range of 1-20 mm, or in a range of 5-15 mm, or about 7-11 mm. It is to be understood that dimensions of D₁, D₂ and T are provided as non-limiting examples, and that the embodiments of the current disclosure are not limited to the disclosed dimensions. Various dimensions of the ceramic article are intended to be included within the scope of the present disclosure. Furthermore, the ceramic article of the instant disclosure may be developed or used for different applications, including, but not limited to, a ceramic spinner for fiber glass wool production.

### Material Design

Many design parameters, including, but not limited to, physical and thermal properties of the materials need to be considered in developing a non-metal spinner. Furthermore, complex interplay between the parameters add additional challenges to the material design. Rationales for the material design in the instant disclosure and results are detailed below.

Physical Properties

1. Strength

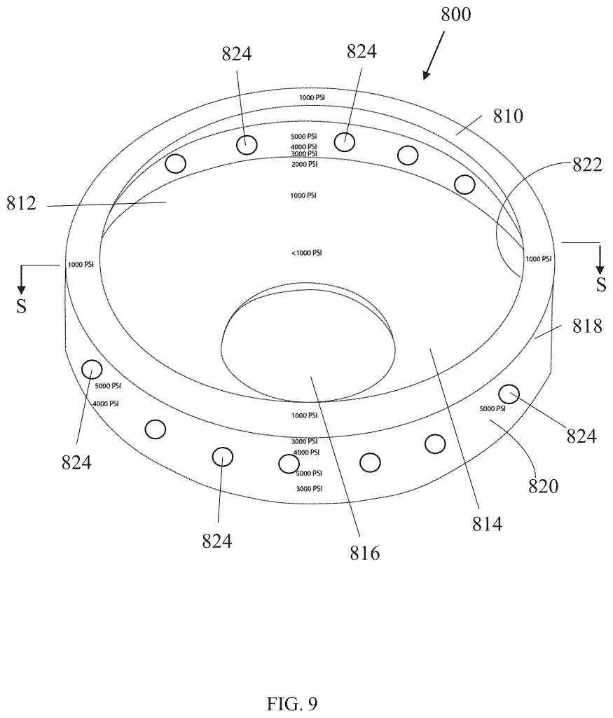

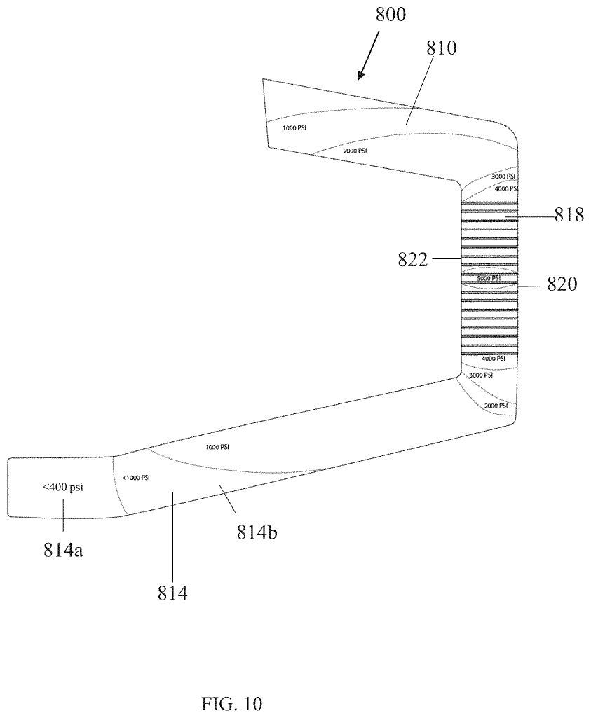

FIG. 9 illustrates a result of a finite element analysis (FEA) that determines the stresses imparted on the ceramic article of FIG. 8A by the rotational forces. The ceramic article of FIG. 9 may be other embodiments of ceramic article such as the one illustrated in FIGS. 2A-2C. It can be seen that base portion 814 of ceramic article 800 generally receives the minimum stress (less than about 400 psi or about 3 MPa from rotation and a cylindrical portion 818 that extends between base portion 814 and top portion 810 generally receives the maximum stress (approximately 5000 psi or 34 MPa) from rotation. FIG. 10 shows more details of the finite element analysis (FEA) results of a portion of the ceramic article of FIG. 9. As illustrated in FIG. 10, the maximum stress from rotation symmetrically impacts cylindrical portion 818 with approximately 5000 psi (34 MPa), where the cylindrical portion 818 extends radially and connects the base portion 814 and a laterally extending top portion 810 of the ceramic article 800. In certain embodiment, the stress from rotation impacts base portion 814 with below 400 psi (or below 3 MPa). In certain embodiments, base portion 814 includes a lateral extending base portion 814a and a sloped base portion 814b coupling the laterally extending base portion to the radially extending cylindrical portion. The lateral extending base portion 814a may receive a stress of less than 400 psi or less than 3 MPa from rotation, and the slope base portion 814b may receive a stress of up to 1000 psi or 7 MPa from rotation. In embodiment, the stress from rotation impacts the laterally extending top portion 810 is in a range of about 1000 psi-3000 psi (about 7-21 MPa).

The current disclosure hypothesizes that ceramic materials with a strength that is at least 5 folds higher than the maximum stress expected in the FEA results may be used as a spinner material, in order to accommodate typical operations as well as any potential mechanical fatigue that may be induced through thermal cycling as well as from the fluctuating load and rotation of the ceramic article. In embodiments, a ceramic material with a modulus of rupture (MOR) in a range of about 5000 psi-25,000 psi (about 34-172 MPa) is used. In embodiments, a ceramic material with a modulus of rupture (MOR) in excess of about 5000 psi or about 34 MPa is used. In embodiments, a ceramic material with a modulus of rupture (MOR) in excess of about 15,000 psi or about 103 MPa is used. In embodiments, silicon carbide with a modulus of rupture (MOR) in excess of about 25,000 psi or about 172 MPa is used. The benefits of the ceramic materials of the disclosure include high tolerance of a magnitude of the stress, including the thermal, primarily tensile stresses induced through startup and shutdown transient states.

2. Resistivity to Deformation/Erosion

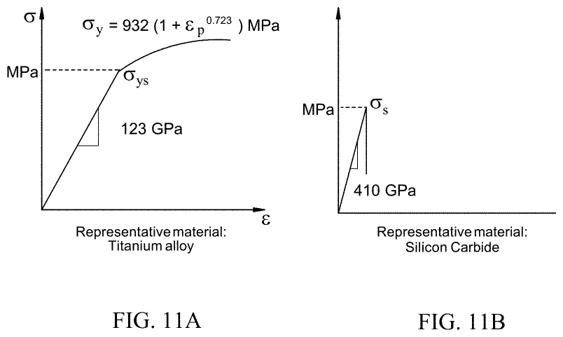

Compared to the conventional metal spinners, the ceramic spinners of the current disclosure have enhanced resistance to deformation and erosion. FIGS. 11A and 11B compare measurements of Stress (σ) vs Strain (ε) Curves of a reference titanium alloy metal material (FIG. 11A) and a silicon carbide material (FIG. 11B) of the instant disclosure, showing changes in stress as stain applied to the material increases. The points marked as σ_{ys} and σₛ in the curves represent the yield strength points of the respective materials. The Young's modulus calculated for titanium alloy (reference) and the silicon carbide material are 123 GPa and 410 GPa, respectively.

Equation 1 represents a Bitter's Equation for erosion parameter of a material:

$$E = \frac{{mV}_{i}^{2}}{2} \frac{( 1 - ( \text{.041} \times {10}^{- 12} ) {H}^{\frac{5}{4}} )}{T} \\ E = EROSION PARAMETER \\ m = MASS OF CONSTANT PARTICLE \\ {V}_{i} = INTIAL VELOCITY OF CONTACT PARTICLE \\ H = TARGET MATERIAL HARDNESS \\ T = TARGET MATERIAL TOUGHNESS \qquad Equation 1$$

In comparing the erosion parameters of metal and ceramic materials, it is assumed in the current disclosure that the kinetic energy of the contact particles would be the same for either case.

$$Constant = {KE}_{impact} = \frac{{mV}_{i}^{2}}{2}$$

A low erosion parameter E correlates to a high resistance to erosion, and in wear applications, the magnitude of E inversely correlates with expected life. That is, the lower the erosion parameter E, the longer an article is able to remain in service. The relationship between hardness and toughness drive the erosion parameter, with hardness having slightly more influence over erosion resistance than toughness.

In embodiments, ASTM C704 test is used to quantitatively measure erosion resistance. ASTM C704 test a 90 deg impingement grit blast at a material sample and then measures the material loss in cubic centimeters. A lower number indicates a more erosion resistance material. In embodiments, the material of the current disclosure includes a silicon carbide having an ASTM C704 test measurement below 3.0 cc, which is significantly lower than that of the conventional metal material used in a metal spinner.

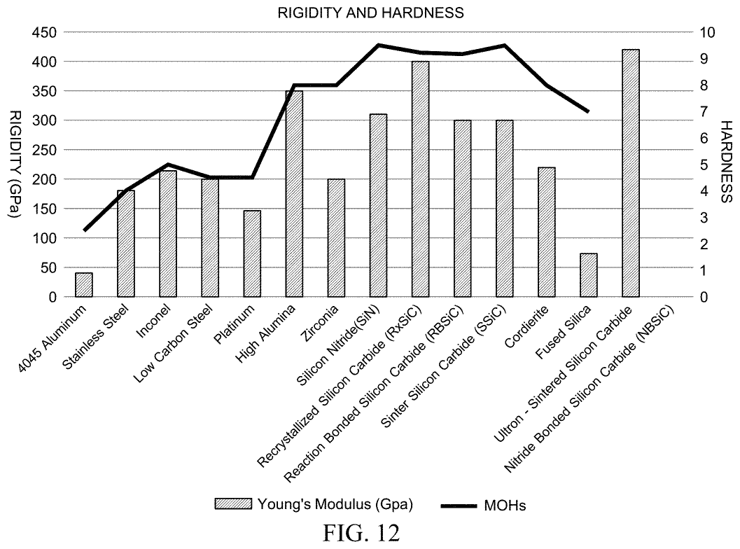

FIG. 12 compares parameters for rigidity (Youngs Modulus, GPa) and hardness (MOH) of various materials for a spinner. It can be seen that the technical ceramic materials of the instant disclosure is characteristically harder, with a far higher elastic modulus than metal (FIG. 12). The combination of a high yield point, a high elastic modulus, and hardness of the materials of the instant disclosure may collectively contribute to improved performance and process improvements. In embodiments, the material that makes up the peripheral outer wall and the peripheral inner wall of the cylindrical portion of the spinner, where the stress is highest, has a module of rupture (MOR) exceeding 100 MPa, a Mohs hardness exceeding 8, or a Young's Modulus exceeding 250 GPa, or any combinations thereof.

3. Oxidation Resistivity

Molten glass is an extremely aggressive oxidizer, atomically comprised of 60-70% oxygen. Platinum, the industry standard due to its strength and relative inertness, completely wets in air or oxygen. Investigations into the wetting properties of molten glass on metals and ceramics show that more easily oxidized metals or alloys are more easily wetted. The ceramic materials of the current disclosure, for example, silicon based ceramic materials, are completely inert to oxidizing environments and significantly less prone to wetting. This would offer significant advantages of reducing the interference of built-up material on the orifice face of the spinner during production and provide yet another process improvement.

Thermal Properties

1. Resistivity to Thermal Shock

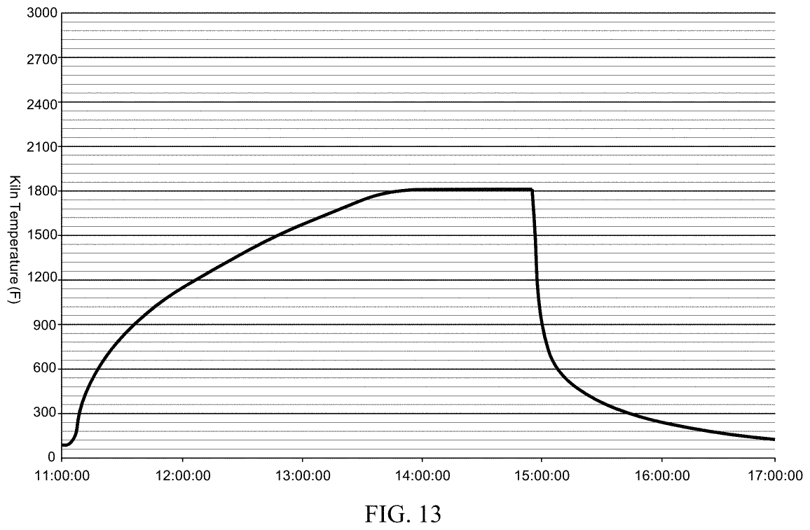

Thermal shock occurs when the temperature gradient across a body of an article results in a stress greater than the strength of the material of the article. Four parameters influence a material's resistance to thermal shock: its ability to transport heat, its thermal expansion, its density, and its strength. Its ability to transport heat, or conductivity, influences thermal shock through thermal gradient. More conductive materials will have a less severe thermal gradient to insulative materials. A material with low expansion and low density has a lower thermally induced stress as result of a thermal gradient compared to a material with high expansion and high density. Finally, strength of a material determines what the maximum stress the material may tolerate without experiencing fracture—the mode of thermal shock failure. FIG. 13 shows a temperature load over time profile of a thermal shock test, where the material of the instant disclosure is quenched from about 1900° F. to about 600° F. and its resultant strength measured to quantify thermal shock resistance.

2. Thermal Cycling Fatigue

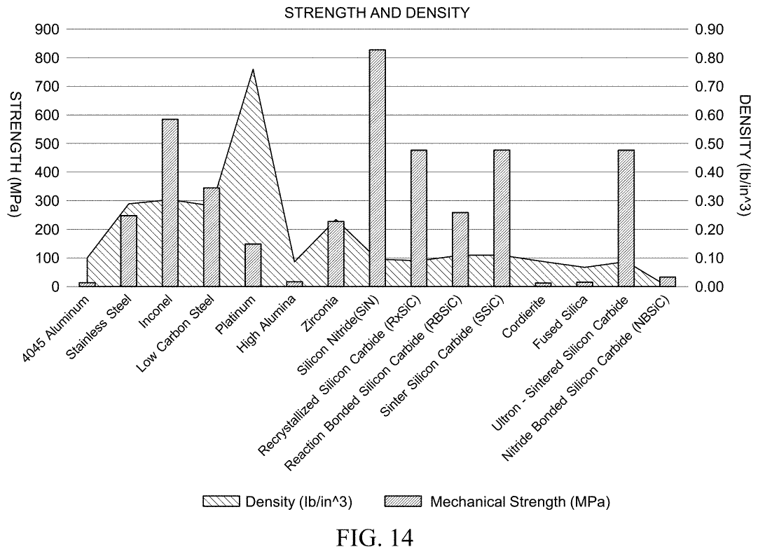

Fatigue is often characterized in terms of mechanical cycling, however it likewise occur when a material's strength degrades as a function of thermal shock cycling. FIG. 14 shows comparison of mechanical strength (MPa) and density (lb/in³) profile of various materials for a spinner. It can be seen that ceramic material, including a nitride bonded silicon carbide material of the current disclosure, combines high strength with a high resistance to thermal shock, which allows it to retain its strength through the thermal cycling experienced in the manufacture of glass wool.

3. Structural Stability

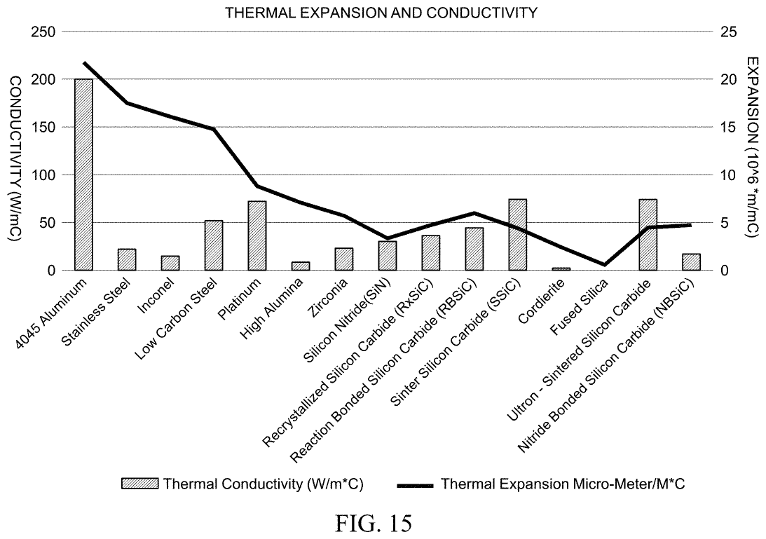

Materials with the least deformation as a result of temperature provide the most structural stability in manufacturing processes that occur at high temperatures. FIG. 15 provides comparison of thermal expansion and thermal conductivity of various materials for a spinner. In some embodiments, the ceramic materials of the instant disclosure have a thermal expansion in a range of 3-6 micro-meter per meter per degree Celsius, or a thermal conductivity in a range of 15-75 Watts per meter per degree Celsius, or both. The ceramic materials of the instant disclosure retain more strength at the same temperature compared to most metals, as well as retaining their shapes and structures due to their relatively low coefficients of thermal expansion.

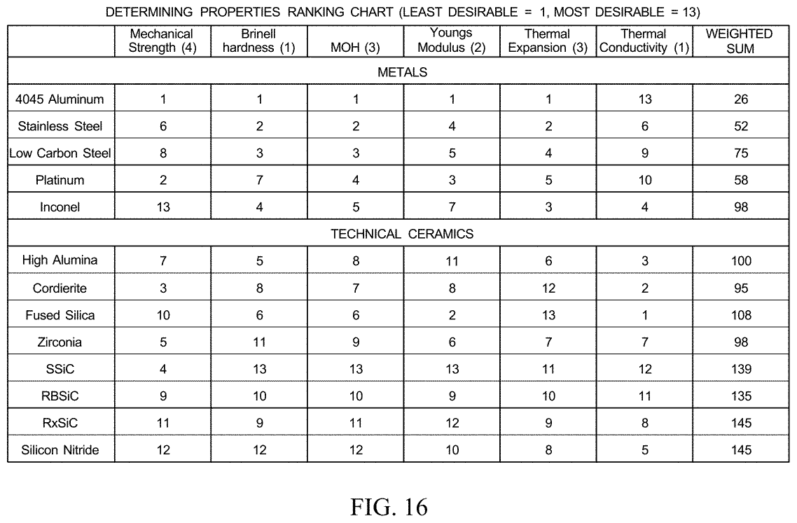

FIG. 16 summarizes a comparison of the material specifications matrix between the materials of the current disclosure and certain reference metals.

Embodiments of the current disclosure provide significant improvements that include, but not limited to:

1. longer spinner life due to significantly improved erosion resistance of the ceramic spinners of the current disclosure.

2. increased yield of highest quality product. The superior properties of the materials of the current disclosure including, but not limited to, erosion parameter, oxidation resistivity, mechanical stability at high temperature, and rigidity all contribute to an increased yield of the highest quality product, for example, glass wool, per spinner. The holes will remain smaller and more uniform to one another for longer, further significantly increasing the lifetime of the spinner.

3. improved structural and thermal stability of ceramic spinners of the current disclosure due to an increased dimensional homogeneity and decreased thermal expansion compared to metal spinners at the extreme temperature of operation.

4. excellent thermal shock resistance. With the conventional metal spinner, during production, there are regular instances of mechanical issues that cause sudden shutdowns in the process. When the process is halted the glass stops being poured in the spinner, all the sources of heat to the spinner are immediately shut off, and the spinner quickly cools. This transient thermal condition induces stresses within the spinner, which could ultimately lead to thermal shock—a result when the thermal stress exceeds the materials strength, and in brittle materials such as certain refractory materials, it could lead to failure. However, due to the high thermal conductivity of the materials of the current disclosure, which lends itself to thermal shock resistance, the thermal gradient would result in a far less severe thermal shock compared to other refractory materials or metals. In embodiments, the technical ceramic material selected may withstand thermal shock scenarios repeatedly during a 1000+ hour expected life span.

5. lower density of the materials of the instant disclosure provides decreased weight compared to conventional metal materials, which in turn result in a decreased strain on the overall system, as well as having a positive influence on the resistance to thermal shock.

6. non-wetting, chemically inert.

7. viable manufacturability for sintered ceramic body. Cast ceramic is at its most fragile in its ‘green’ state, when it is a singular cast piece prior to sintering. While the material of the cast piece is stronger after completing the firing or sintering cycle, the geometry required for the glass spinner has never been achievable through a pure casting process, as micro-cracking in the demolding process would be inevitable. Furthermore, the thin cross section surrounding the hole pattern of a spinner cannot be reliably produced through traditional drilling without cracking or chipping the spinner. Through the introduction of unique machining processes on a sintered ceramic product, as described in the current disclosure, a viable method of manufacture can be achieved. Traditional abrasive drilling methods incur significant costs in machining technical ceramic. For example, materials such as silicon carbide or nitride bonded silicon carbide requires specialized tooling and increased machining time in order to overcome its high strength and hardness. Furthermore, though the material is far stronger sintered, the thin cross section of the hole pattern cannot be reliably produced through traditional drilling without cracking or chipping the part.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

What is claimed is:

1. A ceramic article comprising:
a top portion with a first opening, the first opening having a first diameter;
a base portion with a second opening, the second opening having a second diameter smaller than the first diameter; and
a cylindrical portion extending between the top portion and the base portion, the cylindrical portion having a peripheral outer wall, a peripheral inner wall, and a plurality of through holes extending between the peripheral outer wall and the peripheral inner wall,
wherein the cylindrical portion comprises a material having a module of rupture (MOR) exceeding 100 Megapascals (MPa), a Mohs hardness exceeding 8, or a Young's Modulus exceeding 250 Gigapascals (GPa), or any combinations thereof.

2. The ceramic article in claim 1, wherein the cylindrical portion includes a first region adjacent and surrounding each of the plurality of through holes and a second region adjacent the first region, wherein the material in the first region has a first characteristics, and the material in the second region includes a second characteristics that is different than the first characteristics.

3. The ceramic article in claim 2, wherein the material in the first region has a higher density than that of the material in the second region, thereby providing a higher-density inner surface surrounding each of the plurality of through holes.

4. The ceramic article in claim 3, wherein the higher-density inner surface surrounding each of the plurality of through holes has an average width of about 50 μm.

5. The ceramic article in claim 1, wherein the material has a thermal conductivity in a range of 15-75 Watts per meter per degree Celsius, or a thermal expansion in a range of 3-6 micrometer per meter per degree Celsius, or both.

6. The ceramic article in claim 1, wherein the cylindrical portion extends radially between the top portion and the base portion, and the base portion includes a laterally extending base portion and a sloped base portion coupling the laterally extending base portion to the radially extending cylindrical portion.

7. The ceramic article in claim 1, wherein the plurality of through holes has an average inner diameter range from about 250 μm to about 2.5 millimeter (mm).

8. The ceramic article in claim 1, wherein the material comprises a nitride bonded silicon carbide.

9. The ceramic article in claim 1, wherein the ceramic article is a glass wool spinner.

10. A method for preparing an article from a cast ceramic workpiece, the method comprising:
sintering the cast ceramic workpiece to form a sintered ceramic body, the sintered ceramic body comprising:
a top portion with a first opening, the first opening having a first diameter;
a base portion with a second opening, the second opening having a second diameter smaller than the first diameter; and
a cylindrical portion extending between the top portion and the base portion, the cylindrical portion including a peripheral outer wall and a peripheral inner wall, and
forming a plurality of through holes extending between the peripheral outer wall and the peripheral inner wall of the cylindrical portion, wherein the cylindrical portion comprises a material having a module of rupture (MOR) exceeding 100 Megapascals (MPa), a Mohs hardness exceeding 8, or a Young's Modulus exceeding 250 Gigapascals (GPa), or any combinations thereof.

11. The method of claim 10, wherein the forming further comprises:
determining a region of interests (ROI) in the sintered ceramic body for forming the plurality of through holes;
directing an energy source to the ROI; and
forming the plurality of through holes within the ROI, each of the plurality of through holes extending between the peripheral outer wall and the peripheral inner wall of the cylindrical portion of the sintered ceramic body.

12. The method of claim 11, wherein the energy source is an ultrasound energy or a laser.

13. The method of claim 11, further comprising:
liquifying and vaporizing the material within the ROI in forming the plurality of through holes within the ROI;
liquifying, without vaporizing, the material surrounding each of the plurality of through holes and forming a first region adjacent and surrounding each of the plurality of through holes;
allowing the material in the first region to resolidify; and
wherein the material in the first region has a first characteristics, and the material in a second region adjacent the first region has a second characteristics that is different than the first characteristics.

14. The method of claim 13, further comprising forming a higher-density inner surface of the first region, wherein the higher-density inner surface extends laterally through both the peripheral outer wall and the peripheral inner wall and has a higher material density than that of the second region of the cylindrical portion.

15. The method of claim 14, wherein the higher-density inner surface has an average width of about 50 μm.

16. The method of claim 10, wherein the plurality of through holes has an average inner diameter in a range of about 250 μm to about 2.5 mm.

17. The method of claim 10, wherein the cast ceramic workpiece is a singular cast ceramic workpiece.

18. A ceramic spinner comprising:
a top portion with a first opening, the first opening having a first diameter;
a base portion with a second opening, the second opening having a second diameter smaller than the first diameter; and
a cylindrical portion extending between the top portion and the base portion, the cylindrical portion having a peripheral outer wall, a peripheral inner wall, and a plurality of through holes extending between the peripheral outer wall and the peripheral inner wall, wherein the cylindrical portion further includes a first region adjacent and surrounding each of the plurality of holes and a second region adjacent the first region, and wherein a material in the first region has a first characteristics, and a material in the second region has a second characteristics that is different than the first characteristics.

19. The ceramic spinner of claim 18, wherein the peripheral outer wall and the peripheral inner wall includes a material having a module of rupture (MOR) exceeding 100 MPa, a Mohs hardness exceeding 8, or a Young's Modulus exceeding 250 GPa, or any combinations thereof.

20. The ceramic spinner of claim 18, wherein the material having the first characteristics has a higher density than that of the material having the second characteristics, thereby providing a higher-density inner surface surrounding each of the plurality of through holes.
